(19) United States
(12) Patent Application Publication
(10) Pub. No.: US 2011/0256242 A1
(43) Pub. Date: Oct. 20, 2011

(54) POOL WATER SANITIZER AND METHOD

(76) Inventor: John E. Walls, Kentwood, MI (US)

(21) Appl. No.: 12/761,564

(22) Filed: Apr. 16, 2010

(51) Int. Cl. A01N 59/14; A01P 15/00

(52) U.S. Cl. 424/658

(57) ABSTRACT

A pool water sanitizer composition made of borax hydrate, calcium hypochlorite hydrate, calcium, magnesium, or barium hydroxide, anhydrous calcium chloride, and sodium, lithium or potassium meta silicate hydrate. The composition is substantially free of intentionally added water, and is produced in a low humidity environment at from about 25 to about 40% relative humidity.

### FIELD OF THE INVENTION

The present invention relates to the field of sanitizing compounds for pool, spa and similar bodies of water, and methods of using same.

### SUMMARY OF THE INVENTION

In the present invention, it has been surprisingly found that a non-caking, stable pool sanitizer composition can be made by combining borax hydrate, calcium hypochlorite hydrate, calcium, magnesium, or barium hydroxide, anhydrous calcium chloride, and sodium, lithium or potassium meta silicate hydrate. The composition is substantially free of intentionally added water.

### DESCRIPTION OF THE PREFERRED EMBODIMENTS

In the preferred embodiments, compositions of the present invention have the following ingredients in the indicated percentages:
from about 10% to about 20% borax hydrate;
from about 60% to about 90%, preferably about 65 to about 80%, and most preferably about 70% to about 75% calcium hypochlorite;
from about 2% to about 10%, preferably about 4% to about 8%, and most preferably from about 6% to about 7% calcium hydroxide, magnesium hydroxide, or barium hydroxide;
from about 0.5% to about 4%, preferably 1.0% to about 3% or most preferably from about 1.5% to about 2.5% anhydrous calcium chloride; and
from about 0.5% to about 5%, preferably from about 1% to about 4%, or most preferably from about 2% to about 3% sodium meta silicate hydrate, lithium meta silicate hydrate or potassium meta silicate hydrate.
   The composition is substantially free of intentionally added water.

The term “borax hydrate” refers to hydrous sodium, potassium or lithium tetra borate or mixtures thereof. The penta hydrate form (Na₂B₄O₇.5H₂O) is preferred, but nona and deca hydrate can be used.

Calcium hypochlorite hydrate is typically comprised mainly of the di-hydrate, with some mono-hydrate included. Either the di- or mono-hydrate can be used, or mixtures thereof.

The sodium, potassium or lithium meta silicate hydrate are typically available in the penta hydrate form, though 4,6,8 and 9 water molecules of hydration have been reported for the meta silicates. Of the meta silicates, sodium meta silicate penta hydrate is the most preferred.

Calcium hydroxide is the most preferred hydroxide employed.

The composition is substantially free of intentionally added water. The term “intentionally added water” does not refer to water of hydration which the composition includes. Instead, it is intended to refer to water added over and above the water of hydration. In the preferred embodiment, no water, beyond the water of hydration present, is intentionally introduced into the composition. The term “substantially free” of intentionally added water is intended to prevent someone from avoiding infringement of this patent merely by intentionally adding a meaningless quantity of water to the composition.

It is of course possible for additional water to get into the product inadvertently during the manufacturing process, as for example through the adsorption or absorption of moisture from the air. However, the extent of such inadvertent adsorption or absorption is minimized by manufacturing the product in a low moisture environment of from about 25% to about 40% relative humidity.

The various ingredients of the composition are blended in powdered form. Conventional blenders such as ribbon blenders or tumble mixers can be used. Mill blending or other forms of blending which generate greater mechanical heat than ribbon blenders or tumble mixers should be avoided. The order of addition of the ingredients is not critical, though it is preferable to add the calcium hypochlorite first. As noted above, it is preferable that that the composition be prepared in a low humidity environment, of from about 25% to about 40% relative humidity. Blending at a relative humidity below about 40% keeps the moisture content of the composition down, while blending at above about 25% avoids creating a lot of static electricity during the blending process.

The compositions are preferably sold in powder form. However, they can also be pressed into tablets or discs

### EXAMPLES

### Example 1 (Comparative)

70% (w/w) of calcium hypochlorite.2 H₂O and 30% (w/w) of sodium tetraborate .5 H₂O were blended together. The mixture was stored at 120° F. After 1 hour the material began to decompose with the strong release of chlorine. When allowed to be stored in an open container under ambient conditions, the product is observed to expand, absorb water and eventually turn to a paste within two days. Both results are unacceptable for a commercial product.

### Example 2

A composition of 70% (w/w) calcium hypochlorite.2 H₂O, 20% (w/w) sodium tetraborate.5 H₂O, 2% (w/w) anhydrous calcium chloride, 6% (w/w) calcium hydroxide, and 2% (w/w) sodium metasilicate.5 H₂O was stored at 120° F. After 5 hours there was no change in the appearance, nor was there a detectable release of chlorine. When stored at ambient conditions, there was no noticeable change after three weeks. Both results suggest that the blend is significantly more stable than the composition of the first example.

### Example 3 (Comparative)

In like manner as describe in Example 2, the composition was prepared except that the calcium hydroxide was omitted. When stored at 120° F., it was observed that the blend began to release chlorine after 2 hours. The material stored at ambient was observed to swell and decompose after one week. Although improved over Example 1, the results show the stabilizing influence offered by the calcium hydroxide.

### Example 4 (Comparative)

In like manner as describe in Example 2, the composition was prepared except that the calcium chloride was omitted. When stored at 120° F., it was observed that the blend was stable up to 5 hours. The material stored at ambient was observed to swell and decompose after 8 days. Although improved over Example 1, the results show the stabilizing influence offered by the calcium chloride. The elevated temperature stability was not affected, but ambient storage was poorer, most likely attributable to the lack of an agent to preferably absorb moisture.

### Example 5 (Comparative)

In like manner as describe in Example 2, the composition was prepared except that the sodium metasilicate was omitted. When stored at 120° F., it was observed that the blend began to release chlorine after 3 hours. The material stored at ambient was observed to swell and decompose after 10 days. Although improved over Example 1, the results show the stabilizing influence offered by the sodium metasilicate.

The compositions made in accordance with the present invention provide excellent sanitizing capacity to a swimming pool, spa or the like. They resist caking upon storage. They are more stable than commercially known hypochlorite containing products under a broader range of conditions. Of course it is understood that the foregoing are preferred embodiments of the invention and that various changes and alterations can be made without departing from the spirit and broader aspects thereof as set forth in the appended claims.

1. A water sanitizer composition for pools, spas or the like comprising:
borax hydrate, calcium hypochlorite hydrate, calcium, magnesium, or barium hydroxide, anhydrous calcium chloride, and sodium, lithium or potassium meta silicate hydrate, said composition being substantially free of intentionally added water.

2. The composition of claim 1 which has been produced in a low humidity environment at from about 25% to about 40% relative humidity.

3. The composition of claim 1 comprising:
from about 10% to about 20% borax hydrate;
from about 60% to about 90% calcium hypochlorite hydrate;
from about 2% to about 10% calcium hydroxide, magnesium hydroxide, or barium hydroxide;
from about 0.5% to about 4% anhydrous calcium chloride;
from about 0.5% to about 5% sodium meta silicate hydrate, lithium meta silicate hydrate or potassium meta silicate hydrate.

4. The composition of claim 3 which has been produced in a low humidity environment at from about 25% to about 40% relative humidity.

5. The composition of claim 1 comprising:
from about 10% to about 20% borax hydrate;
from about 65 to about 80% calcium hypochlorite;
from about 4% to about 8% calcium hydroxide, magnesium hydroxide, or barium hydroxide;
from about 1.0% to about 3% anhydrous calcium chloride;
from about 1% to about 4% sodium meta silicate hydrate, lithium meta silicate hydrate or potassium meta silicate hydrate.

6. The composition of claim 5 which has been produced in a low humidity environment at from about 25% to about 40% relative humidity.

7. The composition of claim 1 comprising:
from about 10% to about 20% borax hydrate;
from about 70% to about 75% calcium hypochlorite;
from about 6% to about 7% calcium hydroxide, magnesium hydroxide, or barium hydroxide;
from about 1.5% to about 2.5% anhydrous calcium chloride;
from about 2% to about 3% sodium meta silicate hydrate, lithium meta silicate hydrate or potassium meta silicate hydrate.

8. The composition of claim 7 which has been produced in a low humidity environment at from about 25% to about 40% relative humidity.

9. A method for sanitizing the water in pools, spas or the like comprising introducing a sanitizing amount of a composition comprising:
borax hydrate, calcium hypochlorite, calcium, magnesium, or barium hydroxide, anhydrous calcium chloride and sodium, lithium or potassium meta silicate hydrate; wherein said composition is substantially free of intentionally added water.

10. The method of claim 9 in which the composition has been produced in a low humidity environment at from about 25% to about 40% relative humidity.

11. The method of claim 9 wherein the composition used comprises:
from about 10% to about 20% borax hydrate;
from about 60% to about 90% calcium hypochlorite;
from about 2% to about 10% hydrous calcium hydroxide, magnesium hydroxide, or barium hydroxide;
from about 0.5% to about 4% anhydrous calcium chloride;
from about 0.5% to about 5% sodium meta silicate hydrate, lithium meta silicate hydrate or potassium meta silicate hydrate.

12. The method of claim 11 in which the composition has been produced in a low humidity environment at from about 25% to about 40% relative humidity.

13. The method of claim 9 wherein the composition used comprises:
from about 10% to about 20% borax hydrate;
from about 65 to about 80% calcium hypochlorite;
from about 4% to about 8% calcium hydroxide, magnesium hydroxide, or barium hydroxide;
from about 1.0% to about 3% anhydrous calcium chloride;
from about 1% to about 4% sodium meta silicate hydrate, lithium meta silicate hydrate or potassium meta silicate hydrate.

14. The method of claim 13 in which the composition has been produced in a low humidity environment at from about 25% to about 40% relative humidity.

15. The method of claim 9 wherein the composition used comprises:
from about 10% to about 20% borax hydrate;
from about 70% to about 75% calcium hypochlorite;
from about 6% to about 7% calcium hydroxide, magnesium hydroxide, or barium hydroxide;
from about 1.5% to about 2.5% anhydrous calcium chloride;
from about 2% to about 3% sodium meta silicate hydrate, lithium meta silicate hydrate or potassium meta silicate hydrate

16. The method of claim 15 in which the composition has been produced in a low humidity environment at from about 25% to about 40% relative humidity.
